(19) United States
(12) Patent Application Publication
(10) Pub. No.: US 2002/0197104 A1
(43) Pub. Date: Dec. 26, 2002

(54) Polygon connection assembly

(76) Inventors: Brian Jay Bauman, Ypsilanti, MI (US); Rex Corless, Sterling Heights, MI (US); Mark Hock, Macomb, MI (US); Francis Xavier Kelly, Canton, MI (US); Hsin-Hong Huang, West Bloomfield, MI (US)

Correspondence Address: Steven L Oberholtzer, BRINKS HOFER GILSON & LIONE, P O Box 10395, Chicago, IL, 60610, US

(21) Appl. No.: 09/891,085

(22) Filed: Jun. 25, 2001

(51) Int. Cl. F16B 1/00; B25G 3/28; F16G 11/00

(52) U.S. Cl. 403/274

(57) ABSTRACT

The present invention provides polygonal connections for connecting a shaft with a flange. In a preferred embodiment, the polygon connection includes a polygon shaped recess in the flange, a polygon shaped terminus on the shaft, an outward projection on the terminus, and a groove on the flange. The cross sections of the recess of the flange and the terminus of the shaft are preferably complimentary polygon shapes so that the recess fittingly receives the terminus. An inward projection and ridge cooperatively define the groove of the flange. The groove axially retains the flange on the terminus.

### FIELD OF THE INVENTION

The invention relates generally to a polygon connection between a shaft and a flange.

### BACKGROUND OF THE INVENTION

Rotary energy can be transferred from a shaft to another device by fitting the device onto a terminal end of the shaft. Flanges of various types are frequently used as the device that receives rotary energy from a shaft. In these assemblies, the connection between the flange and the shaft is critical because a poor connection can result in inefficient transfer of rotary energy, slippage of the flange on the shaft, or even complete disconnection of the flange from the shaft.

To avoid these potential problems, a unitary shaft/flange apparatus can be manufactured that eliminates the need for a connection between the two elements. While these constructs may have benefits, they are often large and cumbersome structures making them difficult to manufacture and transport. Furthermore, for large parts such as vehicle axles and drive shafts, a unitary shaft/flange apparatus requires elaborate and expensive forging equipment

Various other types of connections between a shaft and a flange have been proposed and produced. The simplest connection between a shaft and a flange is one in which the shaft has a circular cross section that fits into a slightly larger circular recess in the flange. In these assemblies, there is no interface between the surfaces of the peripheral surface of the shaft with the recess of the flange. Consequently, these connections rely on secondary connectors to transfer the rotary energy from the shaft to the flange. For example, the flange and shaft can both have openings through which bolts or other fasteners can pass, securing one element to the other. The need for extra connectors in these connections increases the expense and weight of constructs employing them.

Another approach to a connection between a shaft and flange involves a forced fit connection. In this arrangement, a shaft having a cross section that is slightly larger in size than the recess of a flange is force fit into the recess. Secondary connectors may also be used in this arrangement. Due to the need for the forced fit, these connections are often difficult to assemble. Some force fit connections utilize temperature induced size changes to allow the flange to be retained on the shaft. While this approach does eliminate the need for some of the forcing during assembly, it still requires precise control of manufacturing conditions to ensure that appropriate temperatures are achieved.

Additionally, some connections rely simply on weld joints between a flange and a shaft, either alone or in combination with bolts and/or other fasteners. As with the simple circular connections mentioned above, the need for weld joints and/or fasteners in this arrangement increases the expense of manufacturing and assembling the connection and also increases the overall weight of the apparatus.

Thus, there is a need for a connection design between a shaft and a flange that allows for a precise fit, efficient transfer of energy between the shaft and the flange, and simple and cost effective manufacturing and assembly of an apparatus utilizing the connection.

### SUMMARY OF THE INVENTION

In a preferred embodiment, the connection relates to a two-piece axle shaft utilizing a polygon connection. This embodiment utilizes a connection between a shaft and a flange comprising a terminus on the shaft having a polygon-shaped cross section, a complimentary shaped recess in the flange, and a groove in the flange that receives and retains an outward projection defined by the terminus of the shaft. In a second embodiment, the connection comprises a yoke attachment that utilizes a polygon spline pilot to improve the interface between the vehicle axle and drive shaft.

### BRIEF DESCRIPTION OF THE DRAWINGS

FIG. 1 is a plan view of a polygon connection between and shaft and a flange in accordance with a first preferred embodiment of the present invention;

FIG. 2 is a plan view of a shaft having a polygon-shaped terminus at one end for use in a connection according to the present invention;

FIG. 3 is a plan view of a flange for receiving and retaining a shaft to form a connection in accordance with the present invention;

FIG. 4 is an exploded view of a driveshaft and flange connection in accordance with a second preferred embodiment of the present invention.

### DETAILED DESCRIPTION OF THE PREFERRED EMBODIMENTS

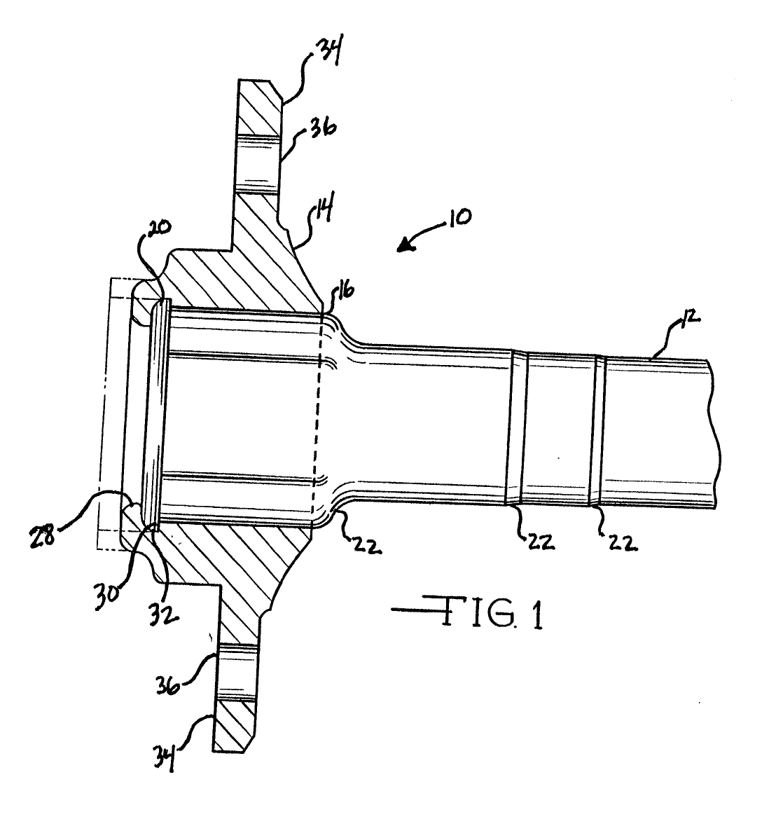

The present invention provides a polygon connection between a shaft and flange. FIG. 1 illustrates one embodiment of a polygon connection 10 according to the present invention. The polygon connection 10 comprises a shaft 12 and flange 14. The shaft 12 is preferably an elongated member having two ends. At least one end of the shaft 12 defines a terminus 16 having a cross section that defines a polygon shape 18. Alternatively, the shaft 14 can be any body having the polygon shape 18, such as a flange in a connection with a yoke.

The polygon shape 18 can take on any polygon configuration, such as a triangle, a square, a pentagon, a hexagon, heptagon, and octagon. Due to ease of manufacturing, a polygon shape 18 having a generally hexagonal shape is preferred. The sides of the polygon shape 18 can be flat, convex, or concave. Without convex or concave sides, the corners of the polygon shape 18 transmit the majority of the torque of the shaft 12 to the flange 14, making them brittle and susceptible to damage. The rounded appearance created by the use of convex or concave sides distributes the load around the perimeter of the polygon shape 18, making the connection 10 stronger. A polygon shape 18 and recess having concave sides are preferred because the shape is able to carry more torque than a convex design.

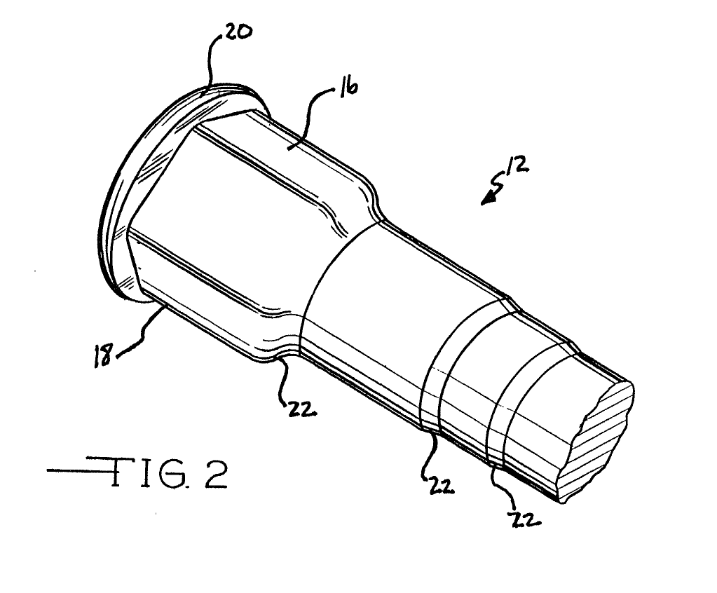

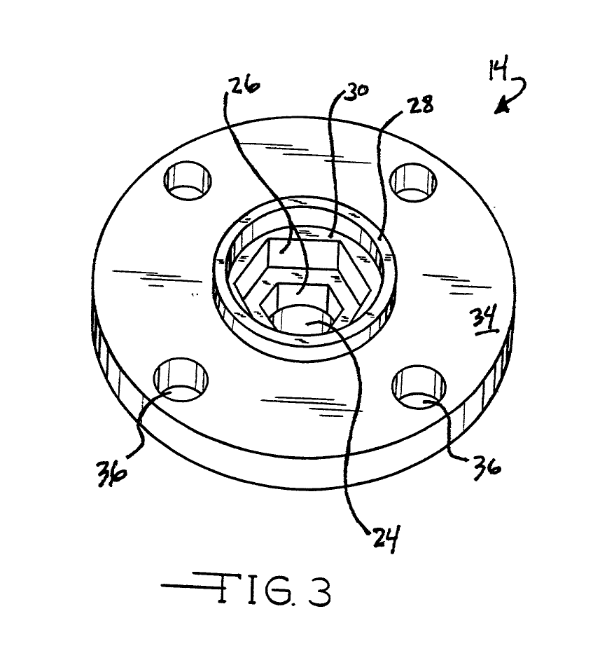

As illustrated in FIGS. 2 and 3, the terminus 16 of the shaft 12 can also define further structural elements that interact with corresponding structural elements on the flange 14 to ensure retention of the shaft 12 on the flange 14. For example, a terminus can define an outward projection 20 that extends away from the central axis of the terminus 16. The outward projection 20 is preferably circumferential around the terminus 16, i.e. the outward projection 20 can extend around the entire perimeter of the terminus 16. Alternatively, the outward projection 20 may be intermittent, effectively defining a plurality of projections around the perimeter of the terminus 16 separated by gaps. When the outward projection 20 is circumferential, it essentially confers a nail head configuration onto the shaft. Also preferable, the outward projection 20 as will be developed more fully below, structurally cooperates with the flange 14 to ensure a stable connection between the shaft 12 and flange 14.

Preferably, the shaft 12 has a constant diameter along its entire length, excluding the polygon shape 18 of the terminus 16. This allows for relatively easy fabrication of the shaft 12. Also preferable, the shaft 12 has a circular cross-sectional shape, except for the polygon shape 18 of the terminus 16. Alternatively, if necessary for interaction with the flange 14, the shaft 12 may define a taper 22 or a plurality of tapers 22 that effectively widen or narrow the diameter of the shaft 12. FIG. 1 illustrates an example of a shaft 12 in which the diameter is gradually widened by a series of tapers 22 until the terminus 16 of the shaft 12 has a diameter comparable to the diameter of the flange 14. Also alternatively, the shaft 12 can have any suitable cross-sectional shape. Indeed, the shaft 12 can have a cross-sectional shape that is the same in size and form as that of the polygon shape 18 of the terminus 16.

The terminus 16 of the shaft 12 may also define a cavity if appropriate for the type of shaft 12 being utilized. A cavity may be desired if a reduced overall weight of the assembly is appropriate. A cavity may also provide a point at which a shaft 12 or an assembly of a shaft 12 and a flange 14 can be manipulated by machinery or an individual. Alternatively, the shaft 12 can be a solid body without a cavity, effectively forming a plug structure.

The shaft 12 is preferably made of steel. Readily available steel, such as 1050 modified steel, that is easily machined is particularly preferred. Alternatively, aluminum, or any other metal, alloy, or other material suitable for the application for which the shaft will be utilized can be used. The shaft 12 is preferably fabricated by methods known in the art, such as forging or machining. Alternatively, the shaft 12 can be fabricated by any suitable method.

Preferably, the flange 14 is a circular member as illustrated in FIG. 3. However, the flange can take on any shape appropriate for the ultimate use to which the assembly between the shaft 12 and flange 14 is being utilized.

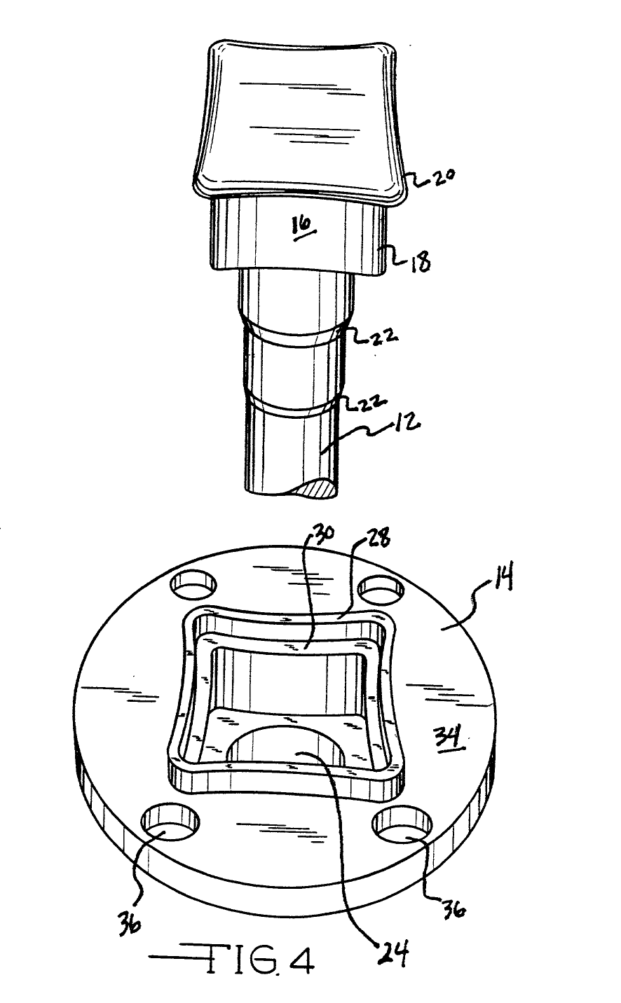

The flange 14 is a separate member that defines a recess 24 for receiving the terminus 16 of the shaft 12. The recess 24 defines a void having a shape that is generally a polygon The shape of the recess 24 is preferably complimentary to the polygon shape 18 defined by the terminus 16 of the shaft 12. Thus, when the terminus 16 defines a square projection, the recess 24 of the flange 14 defines a void in the shape of a square. When the polygon has convex or concave sides, the recess 24 preferably forms an appropriate shape. FIG. 4 shows a flange 14 having a recess 24 that is complimentary in shape to a terminus 16 that defines a polygon shape 18 with concave sides.

The recess 24 is preferably slightly larger in volume than the terminus 16 of the shaft 12. This configuration allows the recess 24 to readily receive the terminus 16 of the shaft 12. Also preferable, the recess 24 is not too large to prevent sufficient contact between the terminus 16 and the outer walls of the recess 24, which would lead to an unstable connection 10. Alternatively, if a force fit or temperature sensitive connection is desired, the recess 24 should be slightly smaller in volume than the terminus 16.

The recess 24 may define stepped polygon shapes 26, which comprise a series of polygon shapes arranged in a step-wise manner. FIG. 3 illustrates this configuration. A flange 14 having a recess 24 defining stepped polygon shapes 26 is able to receive a variety of shafts 12, each having a differently sized terminus 16 appropriate for one of the stepped polygons 26 of the recess 24. This configuration allows the flange 14 to have a reduced overall weight due to the additional material removed from the flange 14. The depth between the stepped polygon shapes 26 can be uniform or varied, depending on the desired interaction with the terminus 16 of the shaft 12. Furthermore, the terminus 16 can define a reciprocal series of polygon projections, if desired.

Preferably, the sides of the recess 24 are perpendicular to the central axis of the flange 14. Alternatively, the sides may have a slight inward taper, slanting toward the center of the recess 24. In this configuration, the inward taper provides an additional mechanism for guiding the terminus 16 of the shaft 12 into the recess 24 of the flange 14.

As best illustrated in FIG. 3, the flange 14 may define several additional structural elements that cooperate with the outward projection 20 of the shaft 12. In a preferred embodiment, the flange defines an inward projection 28, and a ridge 30. These additional elements allow the flange 14 to be retained on the terminus 16 of the shaft 12.

The flange 14 defines an inward projection 28 that extends toward the central axis of the flange 14. FIG. 3 illustrates the inward projection 28 as an upstanding lip, which is the form this element has prior to the preferred method of assembling the polygon connection 10 of the present invention, which will be developed more fully below. The inward projection 28 is preferably a circumferential projection around the perimeter of the flange 14. Alternatively, the inward projection 28 may be intermittent, effectively defining a plurality of inward projections 28 separated by gaps. Opposite the inward projection 28, the flange 14 may also define a ridge 30. The ridge 30 is a shoulder formed in the sidewall of the recess 24 of the flange 14. Similar to the inward projection 28, the ridge 30 is also preferably circumferential in nature. Alternatively, however, the ridge 30 may be intermittent. The inward projection 28 and the ridge 30 are opposing structural elements of the flange 14. As such, the inward projection 28 and the ridge 30 cooperatively define a groove 32, as best illustrated in FIG. 1. The groove 32 is also preferably circumferential in nature, extending around the perimeter of the recess 24. Alternatively, the groove 32 may be intermittent in nature. A series of intermittent inward projections 28, ridges 30, and grooves 32 can be used to create a locking relationship with an intermittent outward projection 20 of the shaft 12.

Preferably, the dimensions of the groove 32 are such that the outward projection 20 of the terminus 16 of the shaft 12 can be positioned within the groove 32. Also preferable, the inward projection 28 defines a particular angle, Preferably, the angle is complimentary to the particular angle defined by outward projection 20 such that no gap exists between the groove 32 and the outward projection 20. This embodiment is illustrated in FIG. 1. Alternatively, the angles may not be complimentary, effectively creating a gap between the outward 20 and inward 28 projections.

Like the shaft 12, the flange 14 is preferably made of steel. Alternatively, the flange 14 may be fabricated from aluminum, any other metal, an alloy, or any other material suitable for the application. The flange 14 is preferably fabricated by techniques known in the art, such as forging and machining. Alternatively, the flange 14 can be fabricated by any suitable method. If present, the inward projection 28 is preferably formed by a roll-forming process, in which a tooling is rotated at a constant angle in a circular travel pattern over the flange and pressing down on the flange lip, an upwardly extending projection. The tooling elastically deforms the lip, creating the inward projection 28. This formation of the inward projection 28 is preferably conducted after the polygon shape 18 of the terminus 16 is fit into the recess 24 of the flange 14, effectively locking the components together and creating the polygon connection 10.

The periphery 34 of the flange 14 may further define elements that allow the flange 14 to take on certain functional characteristics appropriate for the end use of the assembly of the flange 14 and shaft 12. For example, the periphery 34 of the flange 14 may define a single or a plurality of through openings 36. These through openings 36 can serve as passageways for connectors such as bolts, allowing the flange 14 to be secured to another device. This arrangement allows the flange 14 to further transfer a rotary energy from the shaft 12 to the attached device.

As shown in FIG. 4, the polygon shape 18 defined by the terminus 16 of the shaft 12 can have sides that are either convex or concave in nature, effectively giving the polygon 18 a rounded appearance. These convex or concave sides provide an additional degree of alignment when the terminus 16 is being positioned within the recess 24 of the flange 14. Further, the use of concave or convex sides on the polygon 16 provides additional surface contact between the polygon 16 and the recess 24, thereby allowing a more efficient transfer or rotary energy from the shaft 12 to the flange 14.

The foregoing disclosure is the best mode devised by the inventors for practicing the invention. It is apparent, however, that polygon connections incorporating various modifications and variations may be conceivable by one skilled in the art of joining a shaft and flange. Inasmuch as the foregoing disclosure is intended to enable one skilled in the pertinent art to practice the instant invention, it should not be construed to be limited thereby but rather should be construed to include such aforementioned obvious variations and be limited only by the spirit and scope of the following claims.

We claim:

1. A connection assembly, comprising:
a shaft having a first end, said first end defining a cross section having a polygon shape and further defining an outward projection; and
a flange defining a recess having a shape complimentary to said polygon shape of said first end of said shaft, a ridge, and an inward projection opposite said ridge, said ridge and said inward projection cooperatively defining a groove;
wherein said recess rotationally retains said first end of said shaft and said ridge and said inward projection cooperatively axially retain said outward projection in said groove.

2. A connection assembly according to claim 1, wherein said polygon shape of said first end is a member selected from the group consisting of a triangle, a square, a pentagon, a hexagon, a heptagon, and an octagon.

3. A connection assembly according to claim 1, wherein said polygon shape defines convex sides.

4. A connection assembly according to claim 1, wherein said polygon shape defines concave sides.

5. A connection assembly according to claim 1, wherein said outward projection extends continuously around the perimeter of said polygon shape of said first end of said shaft.

6. A connection assembly according to claim 1, wherein said shape of said recess is a member selected from the group consisting of a triangle, a square, a pentagon, a hexagon, a heptagon and an octagon.

7. A connection assembly according to claim 1, wherein said recess defines convex sides.

8. A connection assembly according to claim 1, wherein said recess defines concave sides.

9. A connection assembly according to claim 1, wherein said ridge extends continuously around the perimeter of said recess.

10. A connection assembly according to claim 1, wherein said inward projection extends continuously around the perimeter of said recess.

11. A connection assembly according to claim 1, wherein said groove extends continuously around the perimeter of said recess.

12. A connection assembly according to claim 1, wherein said outward projection defines a first angular surface.

13. A connection assembly according to claim 12, wherein said inward projection defines a second angular surface complimentary to said first angular surface, such that said inward projection, said groove, and said ridge are in continuous contact with said outward projection.

14. A connection assembly, comprising:
a shaft having a first end, said first end defining a cross section having a polygon shape and further defining a circumferential outward projection;
a flange defining a recess having a shape complimentary to said polygon shape of said first end, a circumferential ridge, a circumferential inward projection opposite said ridge, said ridge and said inward projection cooperatively defining a circumferential groove;
wherein said recess rotationally retains said first end of said shaft, and said circumferential ridge and said circumferential inward projection cooperatively axially retain said outward projection in said circumferential groove.

15. The connection assembly of claim 14, wherein said polygon shape of said first end is a member selected from the group consisting of a triangle, a square, a pentagon, a hexagon, a heptagon, and an octagon.

16. A connection assembly according to claim 14, wherein said polygon shape defines convex or concave sides.

17. A connection assembly according to claim 14, wherein said polygon shape defines concave sides.

18. The connection assembly of claim 14, wherein said shape of said recess is a member selected from the group consisting of a triangle, a square, a pentagon, a hexagon, a heptagon, and an octagon.

19. A connection assembly according to claim 14, wherein said recess defines convex sides.

20. A connection assembly according to claim 14, wherein said recess defines concave sides.

21. A connection assembly according to claim 14, wherein said outward projection defines a first angular surface.

22. A connection assembly according to claim 21, wherein said inward projection defines a second angular surface complimentary to said first angular surface, such that said inward projection, and said ridge are in continuous contact with said outward projection.

23. A method of connecting a shaft and a flange, comprising:
providing a shaft having a terminus that defines a polygon shape and an outward projection;
providing a flange having a recess adapted to receive the polygon shape, a ridge, and an upwardly extending projection;
inserting the terminus into the recess such that the outward projection is in continuous contact with the ridge; and
clamping the upwardly extending projection over the outward projection so as to form an inward projection to axially retain the flange and shaft.
